(19) United States
(12) Patent Application Publication
(10) Pub. No.: US 2006/0209889 A1
(43) Pub. Date: Sep. 21, 2006

(54) Bandwidth control device and method

(75) Inventor: Hiroaki Tamai, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/189,946

(22) Filed: Jul. 26, 2005

(30) Foreign Application Priority Data
Mar. 18, 2005 (JP) 2005-079839

(51) Int. Cl. H04J 3/22; H04J 3/16

(52) U.S. Cl. 370/468; 370/470

(57) ABSTRACT

In a bandwidth control device and method in a case where a physical line is used as a plurality of virtual leased lines, a packet length correction value table associates flow identifying information of a packet with a packet length correction value for correcting a length of the packet measured with a specific standard to a packet length corresponding to the flow identifying information; and a bandwidth calculating portion corrects a length of the received packet identified based on the low identifying information, based on the packet length correction value corresponding to the flow identifying information by referring to the packet length correction value table, and determines a transmission timing of the received packet by calculating a bandwidth based on the corrected packet length.

### BACKGROUND OF THE INVENTION

1. Field of the Invention

The present invention relates to a bandwidth control device and method, and in particular to a bandwidth control device and method in a case where a physical line is used as a plurality of virtual leased lines.

Together with rapid advancement of communication technologies in recent years, a transmission rate and traffic on a network have been enhanced, so that a bandwidth for transmission lines has been increased more and more. To accurately control a bandwidth of a packet transmitted to a line is important for efficiently using the line without adversely affecting other lines.

2. Description of the Related Art

### Prior Art Example (1)

FIG. 6 shows a packet switch device 100A to which a prior art bandwidth control device 10A is applied. This packet switch device 100A is provided with the bandwidth control device 10A, a flow identifying/packet-length measuring portion 20, a packet transmission processor 30 and a packet buffer memory 50.

FIG. 7 shows an operation procedure of the packet switch device 100A shown in FIG. 6, which will now be described.

Steps S200-S220: The flow identifying/packet-length measuring portion 20 and the packet buffer memory 50 receive a packet 60_n. The flow identifying/packet-length measuring portion 20 measures the length of the packet 60_n, and provides the packet length 701_n to the bandwidth control device 10A. The packet buffer memory 50 temporarily stores the packet 60_n.

FIG. 8 shows a general packet 60, which is composed of an 8-byte preamble 60a (generally referring to 7-byte preamble+1-byte SFD (Start of Frame Delimiter)), a 14-byte MAC header 60b, a 20-byte IP header 60c, a 20-byte TCP header 60d, a maximum 1460-byte application header data 60e, and a 4-byte FCS 60f. After the packet 60, a 12-byte IPG 70 is inserted.

Steps S230 & S240: At a transmission timing tn (preliminarily calculated at following step S240 based on a length of a packet 60_n−1 just before the packet 60), a bandwidth calculating portion 11A in the bandwidth control device 10A provides transmission instructions 703A_n corresponding to the packet 60_n to the packet transmission processor 30, which transmits the packet 60_n stored in the packet buffer memory 50 to a line based on a flow identification result.

Step S250: The bandwidth calculating portion 11A performs a bandwidth calculation based on the packet length 701 of the packet 60_n, and calculates a transmission timing tn+1 of the subsequent packet 60_n+1, i.e. transmission instructions 703A_n+1 based on the following equation (1).
Transmission timing tn+1=transmission timing tn+output time (based on packet length 701) of packet 60_n×(transmission line bandwidth÷set output bandwidth) Eq. (1)

FIG. 9 shows an example (1) of transmission timings at which packets 60_1-60_5 (n=1-5) are sequentially outputted. FIG. 9 specifically shows timings in a case where the transmission line bandwidth=1 Gbps and the set output bandwidth for the packet 60 of the same flow identification=500 Mbps, namely, the transmission line bandwidth (1 Gbps)÷set output bandwidth (500 Mbps)=“2”. The transmissions of the packets 60_1-60 5 are respectively started according to transmission instructions 703A_1-703A_5 at transmission timings t1-t5. The packet transmission processor 30 outputs transmission completions 704_1-704_5 (not shown in FIG. 6) when the transmission has been completed.

Since the transmission line bandwidth (1 Gbps)÷set output bandwidth (500 Mbps)=“2”, transmission completion time points (transmission time points of transmission completions 704_1-704_5) of the packets 60_1-60_5 respectively reside between transmission timings t1 and t2, t2 and t3, t3 and t4, t4 and t5, and t5 and t6.

### Prior Art Example (2)

In a method of allocating wireless resources by which payload throughput (bandwidth) do not greatly vary according to a compression state of a header, a header compression portion operates a header of a packet transmitted and compresses header information, and a header compression ratio detecting portion detects a header compression ratio or a header length to be attached to the packet. A packet preferential measures determining portion assigns a high priority to a packet whose header compression ratio is low or whose header length is long, and generates a packet and priority information of the packet. A wireless resources assigning control portion assigns wireless resources based on the packet priority information and controls a transmission portion (e.g. see patent document 1).

[Patent document 1] Japanese Patent Application Laid-open No. 2003-143158 (page 1 and FIG. 1)

There is no regulation for the packet length 701 dealt within the device in the above-mentioned prior art example (1). In a MAC chip of a layer 3 packet switch device, for example, a range from the MAC header 60b to the application header data 60e is made the packet length 701 in many cases. This is because the preamble 60a and the IPG 70 need not be considered since the MAC chip uses the packet length 701 when reading the packet 60 from the packet buffer memory storing the packet 60, and the FCS 60f is added after it is deleted since the FCS 60f need be rewritten at the time of transmission. In the prior art packet switch device, the packet length 701 measured for storing the packet 60 in the packet buffer memory 50 and for reading the packet 60 has been used as it is for a bandwidth calculation.

Hereinafter, the problems when the bandwidth calculation is performed by using the packet length 701 (from the MAC header 60b to the application header data 60e) will be described.

When the packet length 701 from the MAC header 60b to the application header data 60e is used, a total of 24 bytes of the preamble 60a, the FCS 60f and the IPG 70 is not reflected in the bandwidth calculation. As a result, a bandwidth error occurs in the bandwidth calculation. Hereinafter, the occurrence of the bandwidth error will be described by taking as an example a case where users 1-10 use 1 Gbps Ethernet (registered trademark) as a virtual leased line of 100 Mbps.

FIGS. 10A and 10B show an example (2) of the packet transmission timing at that time. FIG. 10A shows the transmission timing within the packet switch device, and FIG. 10B shows the transmission timing on the line. Since the transmission line bandwidth (1 Gbps)÷set output bandwidth (100 Mbps)=“10”, transmission timings t1_2-t1_10 (or t′1_2-t′1_10: both are not shown) of users 9-10 intervene between transmission timings t1_1 and t2_1 (or t′1_1 and t′2_1) of the user 1. FIG. 10B is different from FIG. 10A in that the transmission timing on the line takes into account a total of 24 bytes of the preamble 60a, the FCS 60f and the IPG 70.

When the application header data 60e is of 6 bytes and the bandwidth calculation is performed by using the packet length 701, (100 Mbps/54 (bytes)+6 (bytes)) * (54 (bytes)+6 (bytes)+24 (bytes)) =140 Mbps on the line, which adversely affects bandwidths of other user lines. Therefore, if the bandwidth within the device is calculated so that the bandwidth on the line assumes to be 100 Mbps, it is obtained that (100 Mbps/84 (bytes)) * (60 (bytes))=71.4 Mbps. When 71.4 Mbps is set as a bandwidth within the device, and when the application header data 60e receive a 1460-byte packet 60, only the bandwidth on the line up to (71.4 Mbps/54 (bytes)+1460 (bytes) * (54 (bytes)+1460 (bytes)+24 (bytes))=72.54 Mbps can be used. The same applies to a case where the range from the MC header 60b to the FCS 60f is made the packet length 701.

Also, when a single user secures e.g. only 10 application header data 60e (PDU) of 5 Mbps bandwidth, the same problem arises. In this case, it is required to calculate the bandwidth by using the packet length that is the packet length 701 within the device from which the lengths of the MAC header 60b, the IP header 60c, and the TCP header 60d are subtracted. Namely, it is required to correct the packet length 701 used for the bandwidth calculation according to an arbitrary PDU (flow identification) whose bandwidth is secured by the user.

Also, in the prior art example (2), wireless resources are allocated simply based on packet priority information, and a bandwidth control can not be accurately performed.

### SUMMARY OF THE INVENTION

It is accordingly an object of the present invention to provide a bandwidth control device and method in a case where a physical line is used as a plurality of virtual leased lines, wherein a bandwidth for an arbitrary PDU or packet is accurately secured.

In order to achieve the above-mentioned object, a bandwidth control device according to the present invention comprises: a packet length correction value table associating flow identifying information of a packet with a packet length correction value for correcting a length of the packet measured with a specific standard to a packet length corresponding to the flow identifying information; and a bandwidth calculating portion correcting a length of a received packet identified based on the flow identifying information, based on the packet length correction value corresponding to the flow identifying information by referring to the packet length correction value table, and determining a transmission timing of the received packet by calculating a bandwidth based on the corrected packet length.

Namely, in a packet length correction value table, flow identifying information of a packet is associated with a packet length correction value for correcting a length of the packet measured with a specific standard to a packet length corresponding to the flow identifying information. The flow identifying information and a length of a received packet identified based on the flow identifying information are inputted to a bandwidth calculating portion. The bandwidth calculating portion retrieves the packet length correction value corresponding to predetermined flow identifying information as a retrieval key, by referring to the packet length correction value table, corrects the length of the received packet based on the packet length correction value, and determines a transmission timing of the received packet by calculating a bandwidth based on the corrected packet length.

Thus, it becomes possible to secure a packet length measured with a specific standard, e.g. an accurate bandwidth of a packet (arbitrary PDU (Protocol Data Unit)) corresponding to arbitrary flow identifying information designated by a user.

Also, the present invention according to the above-mentioned invention may further comprise a flow identifying/packet-length measuring portion receiving a packet, and providing the flow identifying information for identifying the received packet, and a length of the received packet measured with the specific standard to the bandwidth calculating portion.

Namely, a flow identifying/packet-length measuring portion receives a packet, identifies the received packet based on predetermined flow identifying information, e.g. TCP application flow information, and provides flow identifying information corresponding to a flow of the packet to the bandwidth calculating portion. Furthermore, the flow identifying/packet-length measuring portion measures the received packet with the specific standard (e.g. length from MAC header 60b to application header data 60e (see FIG. 8)), and provides the result (packet length) to the bandwidth calculating portion.

Also, in the present invention according to the above-mentioned invention, the flow identifying information may include header information of a packet of each layer.

Also, in the present invention according to the above-mentioned invention, the packet may include a protocol data unit of each layer. Namely, the packet may be made a protocol data unit of each layer.

In order to achieve the above-mentioned object, a bandwidth control method according to the present invention comprises: a first step of associating flow identifying information of a packet with a packet length correction value for correcting a length of the packet measured with a specific standard to a packet length corresponding to the flow identifying information; and a second step of correcting a length of a received packet identified based on the flow identifying information, based on the packet length correction value corresponding to the flow identifying information by referring to the packet length correction value table, and determining a transmission timing of the received packet by calculating a bandwidth based on the corrected packet length.

As mentioned above, according to the bandwidth control device and method of the present invention, it becomes possible to perform an accurate bandwidth control and to provide a high QoS by making an object of the bandwidth calculation e.g. an arbitrary PDU.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing an arrangement embodiment of a bandwidth control device according to the present invention;

FIG. 2 is a block diagram showing an operation procedure example of a packet switch device to which the bandwidth control device according to the present invention is applied;

FIG. 3 is a diagram showing an example of a packet length correction value table of a bandwidth control device according to the present invention;

FIG. 4 is a flowchart showing an operation embodiment of a bandwidth control device according to the present invention;

FIGS. 5A and 5B are diagrams showing an example of a general IPv4 flow identifying table;

FIG. 6 is a block diagram showing an arrangement of a packet switch device to which a prior art bandwidth control device is applied;

FIG. 7 is a flowchart showing an operation procedure of a packet switch device to which a prior art bandwidth control device is applied;

FIG. 8 is a diagram showing a general Ethernet (registered trademark) packet;

FIG. 9 is a diagram showing an example (1) of a prior art packet transmission timing; and

FIGS. 10A and 10B are diagrams showing an example (2) of a prior art packet transmission timing.

### DESCRIPTION OF THE EMBODIMENTS

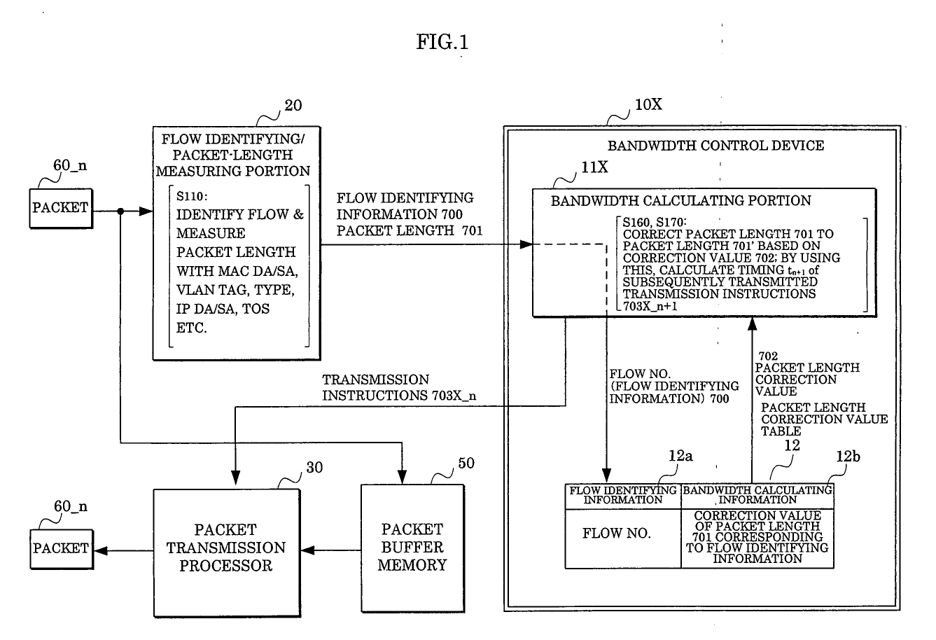

FIG. 1 shows an arrangement embodiment of a bandwidth control device 10X to which the bandwidth control method according to the present invention is applied. Also, FIG. 1 shows peripheral functional portions of the bandwidth control device 10X, which is composed of a bandwidth calculating portion 11X and a packet length correction value table 12.

A flow identifying/packet-length measuring portion 20 and a packet transmission processor 30 are connected to the bandwidth control device 10X. A packet buffer memory 50 is connected to the packet transmission processor 30.

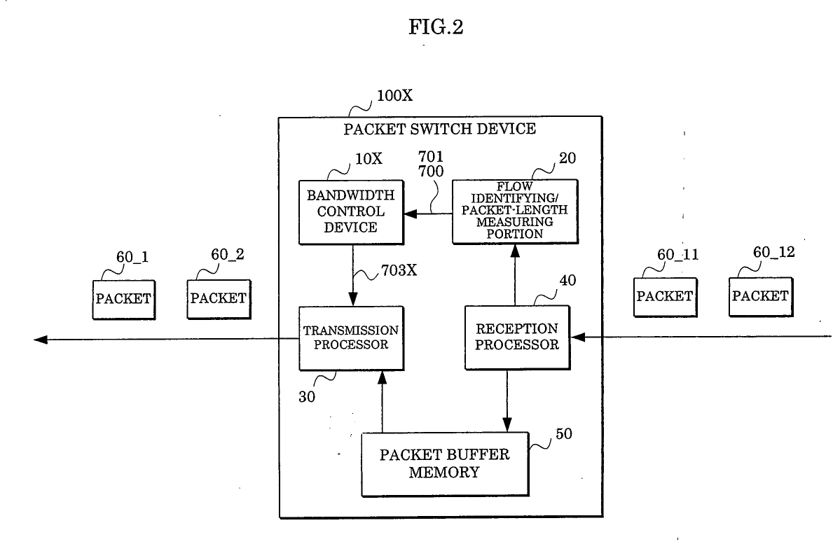

FIG. 2 shows a packet switch device 100X to which the bandwidth control device 10X is applied. The packet switch device 100X is provided with the bandwidth control device 10X, the peripheral functional portions shown in FIG. 1, and further a reception processor 40. This reception processor 40 is connected to the flow identifying/packet-length measuring portion 20 and the packet buffer memory 50.

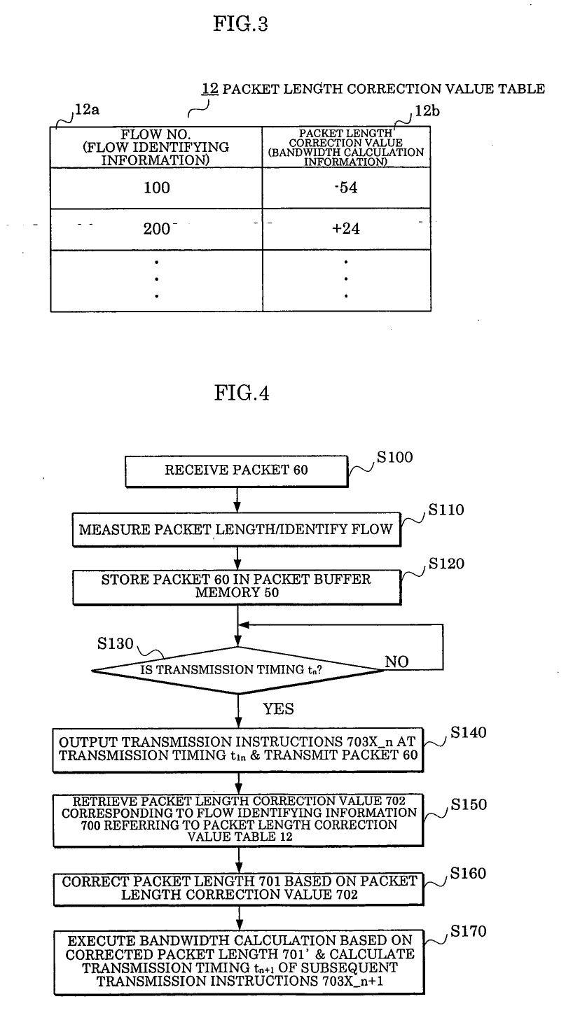

FIG. 3 shows the packet length correction value table 12 shown in FIG. 1. This packet length correction value table 12 is composed of a flow No. (number) 12a that is flow identifying information and a packet length correction value 12b that is bandwidth calculation information.

FIG. 4 shows an operation embodiment of the packet switch device 100X shown in FIG. 2. This operation embodiment will now be described.

Step S100: The reception processor 40 provides a received packet 60_n to the flow identifying/packet-length measuring portion 20 and the packet buffer memory 50.

Steps S110 and S120: The flow identifying/packet-length measuring portion 20 identifies a flow of the provided packet 60, measures the length of the packet 60_n, and provides the resulting flow identifying information 700 and packet length 701 to the bandwidth calculating portion 11X. On the other hand, the packet buffer memory 50 temporarily stores the provided packet 60_n.

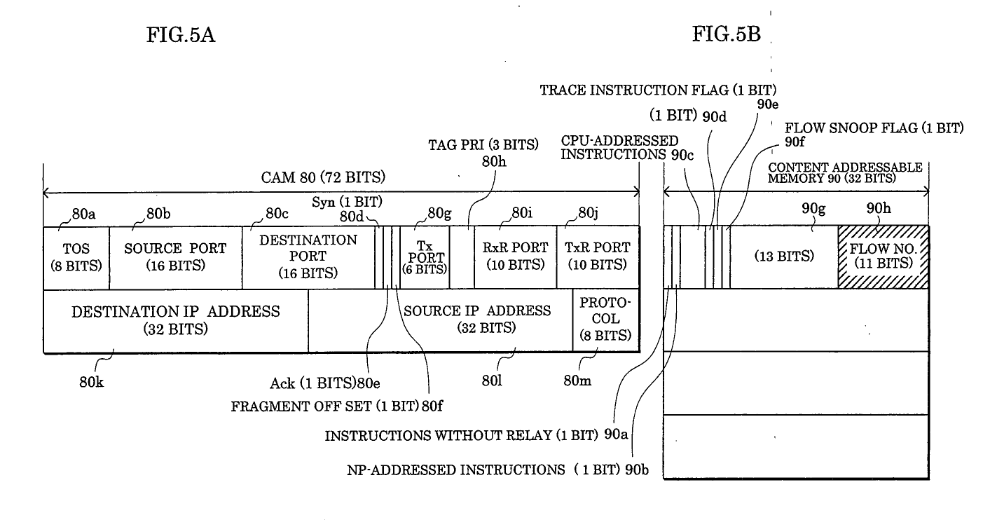

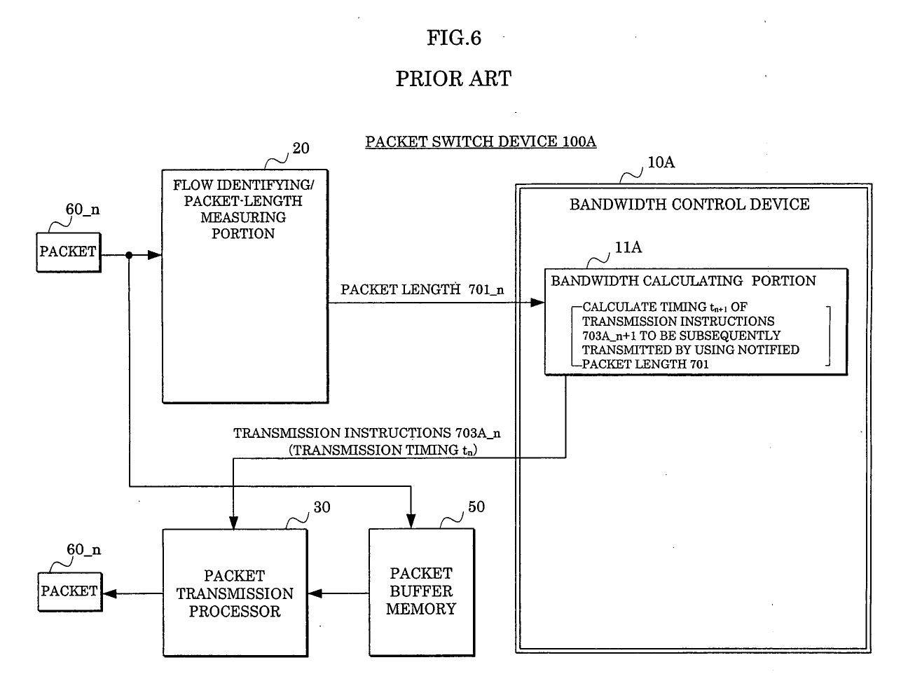

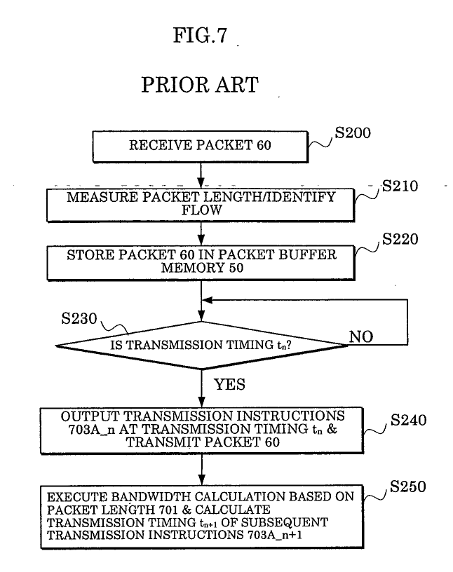

FIGS. 5A and 5B show an example of an IPv4 flow identifying table 200 for obtaining the flow identifying information 700. This IPv4 identifying table 200 will now be described. It is to be noted that while the IPv4 flow identifying table 200 is included in the flow identifying/packet-length measuring portion 20, it may be included in the bandwidth control device 10X.

The IPv4 flow identifying table 200 is composed of an external content retrieval memory (Content-Addressable memory; hereinafter abbreviated as CAM) 80 and a content-addressable memory 90. The external CAM 80 is composed of a TOS 80a, a source port No. 80b, a destination port No. 80c, a syn 80d, an ack 80e, a fragment offset 80f, a Tx port No. 80g, a tag PRI 80h, an RxR port No. 80i, a TxR port No. 80j, a destination IP address 80k, a source IP address 801, and a protocol 80m.

The TOS 80a indicates a TOS field within an IPv4 header, the source port No. 80b indicates a source port No. within a TCP/UDP header, the destination port No. 80c indicates a destination port No. within the TCP/UDP header, the syn 80 indicates a syn bit within the TCP header, and the ack 80e indicates an ack bit within the TCP header. Also, the fragment offset 80f indicates whether or not a packet is a head packet of a fragment. Also, the Tx port No. 80g indicates a transmission logical port No., the tag PRI 80h indicates a PRI value within a VLAN tag of the received packet, the RxR port No indicates a reception router port No., the TxR port No 80j indicates a transmission router port No, the destination IP address 80k indicates a destination IP address, the source IP address 801 indicates a source IP address, and the protocol 80m indicates a protocol within an IPv4 header.

The content-addressable memory 90 is composed of instructions without relay 90a, NP-addressed instructions 90b, CPU-addressed instructions 90c, a trace instruction flag 90d, a specific flow instruction flag 90e, a flow No. 90h, and the like. Among these, the flow No. 90h is used for the present invention, so that the flow identification is designated by this No.

Namely, it is possible to acquire the flow No. 90h which is the flow identifying information 700 from the content-addressable memory 90 with; the tag PRI 80h of the MAC header; the TOS 80a, the destination IP address 80k, the source IP address 801 and the protocol 80m of the IPv4 header; the source port No. 80b, the destination port No. 80c, the syn 80d and the ack 80e of the TCP/UDP header; the fragment offset 80f of in-device information (flow identification preprocessing result); the Tx port No. 80g; the RxR port No. 80i; and the TxR port No. 80j, as a retrieval key. A specific example of this flow No. acquisition will now be described.

### EXAMPLE (1)

When an application using the destination IP address 80k=“10.10.1.1” and the destination port No. 80c of the TCP=“15000” is desired to be identified, a retrieval is performed with the destination IP address 80k=10.10.1.1, the protocol 80m=“6 (TCP)” and destination port Nos. except destination port No. 80c=15000 being masked (omitting from retrieval objects), and a value=e.g. “100” (preset) of the flow No. 90h of the content-addressable memory 90 corresponding to a retrieval hit address is acquired.

### EXAMPLE (2)

When a user packet whose subnet address of the source IP address is “10.10.2” is desired to be identified, a retrieval is further performed with the source IP addresses except the source IP address 801=10.10.2 (last 1 byte is masked) being masked, so that the value=e,g, “200” of the flow No. 90h of the content-addressable memory 90 corresponding to the retrieval hit address is acquired.

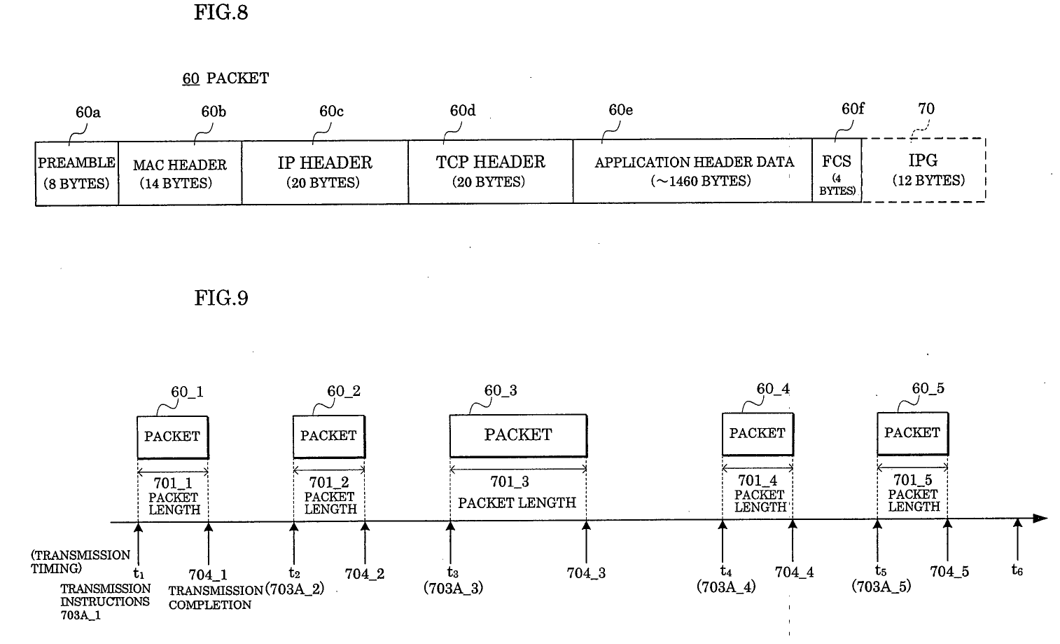

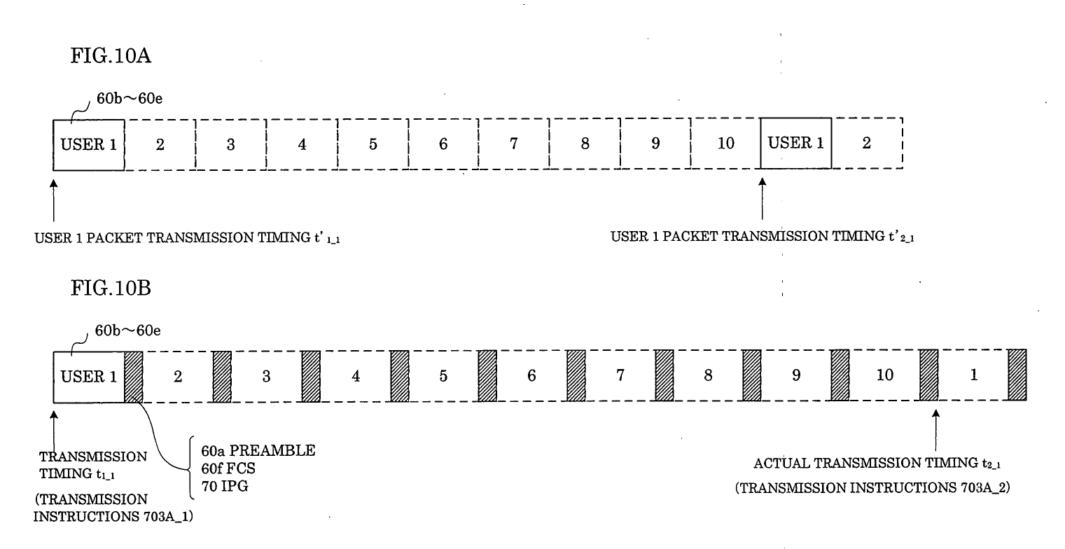

The packet identified by the flow No. 90h=“100” in the above-mentioned example (1) is a TCP application. When a user desires to secure a bandwidth by the application header data (PDU), a bandwidth calculation has to be performed based on the packet length corrected by subtracting the MAC header 60b=“14 bytes”, the IP header 60c=“20 bytes”, and the TCP header 60d=“20 bytes” from the packet length 701 (see FIG. 8). Therefore, the flow No. 12a=“100” and the packet length correction value 12b=“−54” are associated with each other and registered in the packet length correction value table 12 shown in FIG. 3.

Similarly, the packet identified by the flow No. 90h=“200” in the above-mentioned example (2) is a packet for a specific user. When a user desires to secure a bandwidth as a virtual leased line, a bandwidth calculation has to be performed based on the packet length corrected by adding the preamble 60a=“8 bytes”, the FCS 60f=“4 bytes” and the IPG 70=“12 bytes” to the packet length 701. Therefore, the flow No. 12a=“200” and the packet length correction value 12b=“+24” are associated with each other and registered in the packet length correction value table 12.

Steps S130 and S140: The bandwidth calculating portion 11X provides transmission instructions 703X_n to the transmission processor 30 when the timing assumes the transmission timing tn calculated at subsequent steps S150-S170, based on the flow identifying information 700 and the packet length 701 of a packet 60_n-1 just before the packet 60_n.

Steps S150-S170: The bandwidth calculating portion 11X acquires e.g. the packet length correction value 12b=“−54” corresponding to the flow No. 12a=“100” referring to the packet length correction value table 12, corrects the packet length 701 by this value “−54”, calculates the bandwidth based on a packet length 701′ which is a correction result, and calculates a transmission timing tn+1 of the subsequent transmission instructions 703X_n+1. Thus, it becomes possible to calculate an accurate bandwidth corresponding to an arbitrary PDU.

What is claimed is:

1. A bandwidth control device comprising:
a packet length correction value table associating flow identifying information of a packet with a packet length correction value for correcting a length of the packet measured with a specific standard to a packet length corresponding to the flow identifying information; and
a bandwidth calculating portion correcting a length of a received packet identified based on the flow identifying information, based on the packet length correction value corresponding to the flow identifying information by referring to the packet length correction value table, and determining a transmission timing of the received packet by calculating a bandwidth based on the corrected packet length.

2. The bandwidth control device as claimed in claim 1, further comprising a flow identifying/packet-length measuring portion receiving a packet, and providing the flow identifying information for identifying the received packet, and a length of the received packet measured with the specific standard to the bandwidth calculating portion.

3. The bandwidth control device as claimed in claim 1, wherein the flow identifying information includes header information of a packet of each layer.

4. The bandwidth control device as claimed in claim 1, wherein the packet includes a protocol data unit of each layer.

5. A bandwidth control method comprising:
a first step of associating flow identifying information of a packet with a packet length correction value for correcting a length of the packet measured with a specific standard to a packet length corresponding to the flow identifying information; and
a second step of correcting a length of a received packet identified based on the flow identifying information, based on the packet length correction value corresponding to the flow identifying information by referring to the packet length correction value table, and determining a transmission timing of the received packet by calculating a bandwidth based on the corrected packet length.
